(19) United States
(12) Patent Application Publication
(10) Pub. No.: US 2016/0217805 A1
(43) Pub. Date: Jul. 28, 2016

(54) VOICE SIGNAL PROCESSING APPARATUS AND VOICE SIGNAL PROCESSING METHOD

(71) Applicant: Acer Incorporated, New Taipei City (TW)

(72) Inventors: Po-Jen Tu, New Taipei City (TW); Jia-Ren Chang, New Taipei City (TW); Kai-Meng Tzeng, New Taipei City (TW)

(21) Appl. No.: 14/736,289

(22) Filed: Jun. 11, 2015

(30) Foreign Application Priority Data
Jan. 23, 2015 (TW) 104102320

(51) Int. Cl. G10L 21/0332; G10L 21/01; G10L 21/0364; G10L 21/013

(52) U.S. Cl. CPC G10L 21/0332; G10L 21/013; G10L 21/01; G10L 21/0364

(57) ABSTRACT

A voice signal processing apparatus and a voice signal processing method are provided. Calculate a value of an interpolation parametric function corresponding to a sampling signal frame according to three consecutive sample values in the sampling signal frame, and calculate an interpolated value between two adjacent sampling points in a frequency-lowered signal frame according to the value of the interpolation parametric function.

### CROSS-REFERENCE TO RELATED APPLICATION

This application claims the priority benefit of Taiwan application serial no. 104102320, filed on Jan. 23, 2015. The entirety of the above-mentioned patent application is hereby incorporated by reference herein and made a part of this specification.

### BACKGROUND OF THE DISCLOSURE

1. Field of the Disclosure

The disclosure relates to a method and a signal processing apparatus, and more particularly relates to a voice signal processing apparatus and a voice signal processing method.

2. Description of Related Art

In general, hearing-impaired people can clearly hear low frequency signals but have trouble receiving high frequency voice signals (e.g., a consonant signal). However, after the frequency of the signal is lowered, due to the increase of the time length, the signal value between the continuous two sampling signals is obtained by interpolation. For example, when the frequency of a voice signal is lowered from the high frequency signal into a low frequency signal to have half of the frequency, the time length is increased to be twice of the original, then the interpolation method is required to achieve the sampling signal and new signal between the sampling signals. Since the characteristic of voice signal is relatively close to sinusoidal, if the general arithmetic mean is used to calculate the interpolated signal value, the frequency-lowered signals may tend to lead to signal distortion.

### SUMMARY OF THE DISCLOSURE

The disclosure provides a voice signal processing apparatus and a voice signal processing method, capable of effectively avoiding the situation that the frequency-lowered voice signal leads to signal distortion.

The voice signal processing apparatus includes a processing unit, which receives a sampling voice signal including a sequence of sampling signal frames, calculates a value of an interpolation parametric function corresponding to each of the sampling signal frames according to consecutive three sample values in each of the sampling signal frames, lowers a frequency of the sampling voice signal to generate a frequency-lowered signal including a sequence of frequency-lowered signal frames, calculates an interpolated value between two adjacent sampling points in each of the frequency-lowered signal frames according to a value of the interpolation parametric function corresponding to each of the frequency-lowered signal frames.

According to an exemplary embodiment of the disclosure, the voice signal processing apparatus further includes a sampling unit, coupled to the processing unit, sampling an original voice signal to generate the sampling voice signal. The processing unit further determines whether the value of the interpolation parametric function is smaller than an upper limit value and greater than or equal to a lower limit value, if the value of the interpolation parametric function is not smaller than the upper limit value or not greater than or not equal to the lower limit value, correcting the value of the interpolation parametric function.

According to an exemplary embodiment of the disclosure, if the value of the interpolation parametric function is greater than or equal to the upper limit value, the value of the interpolation parametric function is corrected to be the upper limit value, if the value of the interpolation parametric function is smaller than the lower limit value, the value of the interpolation parametric function is corrected to be the lower limit value.

According to an exemplary embodiment of the disclosure, the upper limit value and the lower limit value are correlated to a frequency of the original voice signal and a sampling frequency of the sampling unit.

According to an exemplary embodiment of the disclosure, the processing unit further calculates the value of the interpolation parametric function corresponding to each of the sampling signal frames according to trigonometric relationship of the consecutive three sample values in each of the sampling signal frames.

According to an exemplary embodiment of the disclosure, the interpolation parametric function is a trigonometric function.

The voice signal processing method of the disclosure includes the following steps: sampling an original voice signal to generate a sampling voice signal including a sequence of sampling signal frames; calculating a value of an interpolation parametric function corresponding to each of the sampling signal frames according to consecutive three sample values in each of the sampling signal frames; lowering a frequency of the sampling voice signal to generate a frequency-lowered signal including a sequence of frequency-lowered signal frames; and calculating an interpolated value between two adjacent sampling points in each of the frequency-lowered signal frames according to a value of the interpolation parametric function corresponding to each of the frequency-lowered signal frames.

According to an exemplary embodiment of the disclosure, the voice signal processing method further includes the step of determining whether the value of the interpolation parametric function is smaller than an upper limit value and greater than or equal to a lower limit value, if the value of the interpolation parametric function is not smaller than the upper limit value or not greater than or not equal to the lower limit value, correcting the value of the interpolation parametric function.

According to an exemplary embodiment of the disclosure, if the value of the interpolation parametric function is greater than or equal to the upper limit value, the value of the interpolation parametric function is corrected to be the upper limit value, if the value of the interpolation parametric function is smaller than the lower limit value, the value of the interpolation parametric function is corrected to be the lower limit value.

According to an exemplary embodiment of the disclosure, the upper limit value and the lower limit value are correlated to a frequency of the original voice signal and a sampling frequency of the sampling unit.

According to an exemplary embodiment of the disclosure, the voice signal processing method further includes the step of calculating the value of the interpolation parametric function corresponding to each of the sampling signal frames according to trigonometric relationship of the consecutive three sample values in each of the sampling signal frames.

According to an exemplary embodiment of the disclosure, the interpolation parametric function is a trigonometric function.

In light of the above, in the embodiment of the disclosure, the value of the interpolation parametric function corresponding to each of the sampling signal frames is calculated according to consecutive three sample values in each of the sampling signal frames, the interpolated value between two adjacent sampling points in each of the frequency-lowered signal frames is calculated according to the value of the interpolation parametric function corresponding to each of the frequency-lowered signal frames, in order to achieve a precise interpolated value, so that the situation that the frequency-lowered voice signal leads to signal distortion may be effectively avoided.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a voice signal processing apparatus according to one embodiment of the disclosure.

FIG. 2 is a schematic view of frequency-lowered signals according to one embodiment of the disclosure.

FIG. 3 is a flow chart schematically illustrating a voice signal processing method according to one embodiment of the disclosure.

### DESCRIPTION OF THE EMBODIMENTS

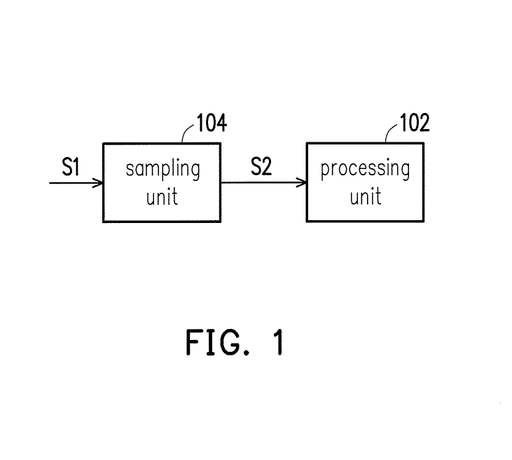

FIG. 1 is a schematic view of a voice signal processing apparatus according to one embodiment of the disclosure. Please refer to FIG. 1. The voice signal processing device includes a processing unit 102 and a sampling unit 104, the processing unit 102 coupled to the sampling unit 104, wherein the processing unit 102 may be, for example, implemented by a central processing unit, and the sampling unit 104 may be implemented by a logic circuit, but the disclosure is not limited to the above. The sampling unit 104 may sample an original voice signal S1 to generate a sampling voice signal S2, wherein the sampling voice signal S2 includes a sequence of sampling signal frames. The processing unit 102 may calculate a value of an interpolation parametric function corresponding to each of the sampling signal frames according to consecutive three sample values in each of the sampling signal frames, additionally may lower a frequency of the sampling voice signal S2 to generate a frequency-lowered signal including a sequence of frequency-lowered signal frames, and may calculate an interpolated value between two adjacent sampling points in each of the frequency-lowered signal frames according to a value of the interpolation parametric function corresponding to each of the frequency-lowered signal frames, wherein the value of the interpolation parametric function is a trigonometric function, e.g., sine function or cosine function, but it is not limited thereto.

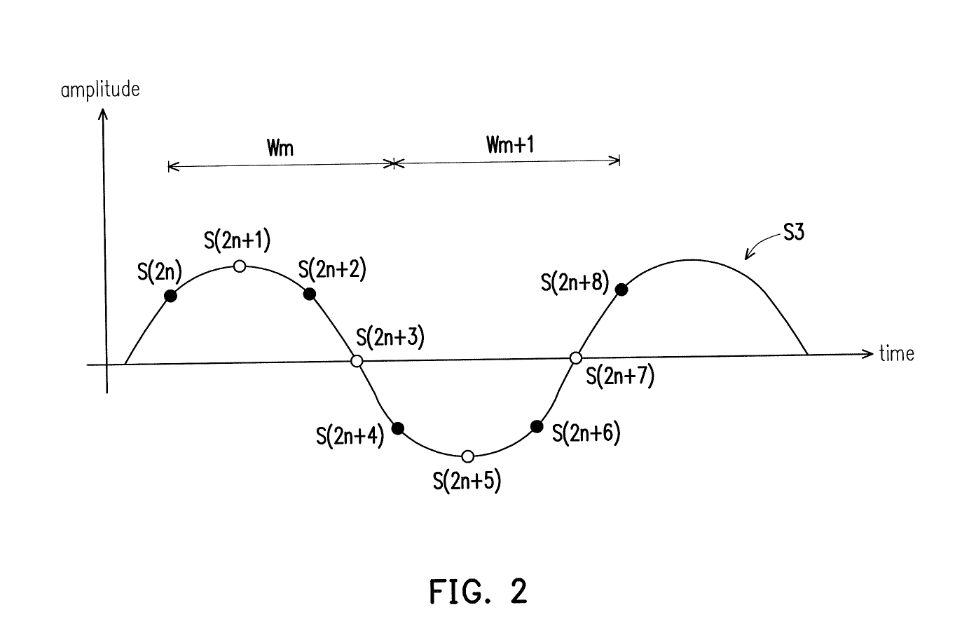

For example, FIG. 2 is a schematic view of frequency-lowered signals according to one embodiment of the disclosure, and please refer to FIG. 2. In FIG. 2, the solid circles are sampling points of the sampling unit 104, and the hollow circles are the interpolated points calculated by the processing unit 102. Herein it is assumed that the sample value at the time n in the m^{th} sampling signal frame in the sampling voice signal S2 is \hat{B}2ₘ(n), wherein m is a positive integer, n is 0 or a positive integer. In addition, in the embodiment, the frequency of the frequency-lowered signal S3 obtained by lowering the frequency of the sampling voice signal S2 is one half of the frequency of the sampling voice signal S2. If it is assumed that the sample value at the time n in the m^{th} frequency-lowered signal frame Wm (corresponding to the m^{th} sampling signal frame of the sampling voice signal S2) in the frequency-lowered signal S3 is sₘ(n), then the corresponding relation of the same sampling point before and after the frequency being lowered is as follows:

sₘ(2n)=\hat{B}2ₘ(n) (1)

The processing unit 102 may calculate the value of the interpolation parametric function corresponding to each of the sampling signal frames according to consecutive three sample values in each of the sampling signal frames, for example, the interpolation parametric function corresponding to the m^{th} sampling signal frame Cₘ(g) may be calculated according to the trigonometric function relationship of the consecutive three sampling points \hat{B}2ₘ(2g), \hat{B}2ₘ(2g+1) and \hat{B}2ₘ(2g+2) in the sampling signal frames sampled by the sampling unit 104, the corresponding interpolation parametric function within the time range of the sampling signal frame is shown in the following equation:

$${C}_{m} ( g ) = \frac{\hat{B} {2}_{m} ( 2 g ) + \hat{B} {2}_{m} ( 2 g + 2 ) + 2 \hat{B} {2}_{m} ( 2 g + 1 )}{4 \hat{B} {2}_{m} ( 2 g + 1 )} \qquad ( 2 )$$

Wherein g is 0 or a positive integer, Cₘ(g) is the function value of the interpolation parametric function at the time g, the interpolation parametric function Cₘ(g) is a trigonometric function.

Since noise signals may be generated when the voice signal processing apparatus performs the signal processing, thereby resulting that the value of the calculated interpolation parametric function may include undesired noise, this may affect the precision of the interpolated value calculated by the processing unit 102. The processing unit 102 may inspect whether the value of the interpolation parametric function is affected by the noise signal through determining whether the value of the interpolation parametric function is within a predetermined range, for example, determining whether the value of the interpolation parametric function is smaller than an upper limit value and greater than or equal to a lower limit value, wherein if the value of the interpolation parametric function is not smaller than the upper limit value or not greater than or not equal to the lower limit value, then it represents that the value of the interpolation parametric function is affected by the noise signal. The processing unit 102 may correct the value of the interpolation parametric function so as to eliminate the noise signal composition included in the value of the interpolation parametric function. For example, if the value of the interpolation parametric function is greater than or equal to the upper limit value, the processing unit 102 may correct the value of the interpolation parametric function to be the upper limit value, if the value of the interpolation parametric function is smaller than the lower limit value, the processing unit 102 may correct the value of the interpolation parametric function to be the lower limit value, and if the value of the interpolation parametric function is smaller than the upper limit value and greater than or equal to the lower limit value, then it is no need to correct the value of the interpolation parametric function. For example, in the embodiment shown in FIG. 2, the correcting method of the value of the interpolation parametric function Cₘ(g) is shown in the following equation:

$${C}_{m} ( g ) = \{ \begin{matrix}{C}_{m} ( g ) , & 0.5 \leq {C}_{m} ( g ) < 1 \\ 0.5 , & {C}_{m} ( g ) < 0.5 \\ 1 , & {C}_{m} ( g ) \geq 1\end{matrix} \qquad ( 3 )$$

Namely, the upper limit value and the lower limit value as mentioned in FIG. 2 of the embodiment are 1 and 0.5, respectively. If the voice signal processing apparatus is affected during the signal processing by the noise signal and the value of the interpolation parametric function Cₘ(g) is greater than or equal to 1, then the processing unit 102 may correct the value of the interpolation parametric function Cₘ(g) to be 1, if the value of the interpolation parametric function Cₘ(g) is smaller than 0.5, then the processing unit 102 may correct the value of the interpolation parametric function Cₘ(g) to be 0.5. It should be noted that, the upper limit value and the lower limit value of Equation (3) are not limited in the description of the exemplary embodiment consistent with the disclosure. Herein the upper limit value and the lower limit value may be adjusted according to actual situation of the noise signal, for example, the upper limit value and the lower limit value may be adjusted according to the frequency of the original voice signal and the sampling frequency of the sampling unit.

After the value of the interpolation parametric function is obtained, the processing unit 102 may calculate the interpolated value between the two adjacent sampling points in each of the frequency-lowered signal frames according to the value of the interpolation parametric function. Taking the embodiment shown in FIG. 2 as an example, in the frequency-lowered signal frame Wm, the interpolated value s(2n+1) between the sampling points s(2n), s(2n+2) and the interpolated value s(2n+3) between the sampling points s(2n+2), s(2n+4) are shown in the following equations:

$$\begin{matrix}s ( 2 n + 1 ) = \frac{s ( 2 n ) + s ( 2 n + 2 )}{2 \sqrt{{C}_{m} ( \frac{n}{2} )}} & ( 4 ) \\ s ( 2 n + 3 ) = \frac{s ( 2 n + 2 ) + s ( 2 n + 4 )}{2 \sqrt{{C}_{m} ( \frac{n}{2} )}} & ( 5 )\end{matrix}$$

In Equation (4) and Equation (5), n is 0 or a positive even number. Similarly, the interpolated value between other sampling points in the frequency-lowered signal frame may also be obtained by the same method, for example, in the frequency-lowered signal frame Wm+1 shown in FIG. 2, the interpolated value s(2n+5) between the sampling points s(2n+4), s(2n+6) and the interpolated value s(2n+7) between the sampling points s(2n+6), s(2n+8) may also be obtained by the method mentioned in the embodiment of FIG. 2, people of ordinary skill in the art can easily derive other implementation from the disclosure, and the description of such details will not be illustrated herein again.

As abovementioned, in the embodiment, the interpolated value between the sampling points is calculated by using trigonometric function, and the interpolated value between the two adjacent sampling points in the frequency-lowered signal frame is calculated according to the interpolation parametric function. Since the characteristics of trigonometric function and voice signal are comparatively similar, compared to the conventional method that simply uses arithmetic mean to obtain the interpolated value, the calculating method of the embodiment may achieve a more precise interpolated value, and thereby the situation that the frequency-lowered voice signal leads to signal distortion may be effectively avoided.

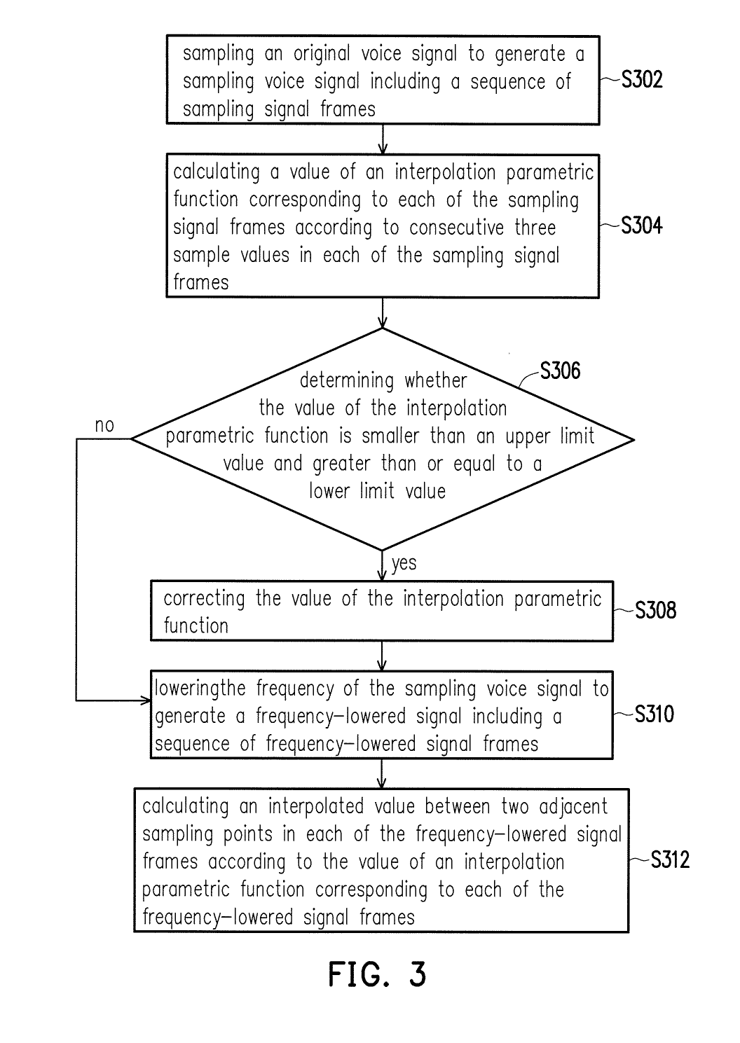

FIG. 3 is a flow chart schematically illustrating a voice signal processing method according to one embodiment of the disclosure, please refer to FIG. 3. As mentioned in the above embodiment, the voice signal processing method of the voice signal processing method of the disclosure includes the following steps. First, an original voice signal is sampled to generate a sampling voice signal including a sequence of sampling signal frames (step S302). Next, the value of the interpolation parametric function corresponding to each of the sampling signal frames is calculated according to the consecutive three sample values in each of the sampling signal frames (step 304), wherein the interpolation parametric function may be calculated according to the trigonometric function relationship of the consecutive three sampling points in the sampling signal frames, and the interpolation parametric function may be trigonometric function. After that, it may be determined whether the value of the interpolation parametric function is smaller than an upper limit value and greater than or equal to a lower limit value (step S306), if the value of the interpolation parametric function is not smaller than the upper limit value or not greater than or not equal to the lower limit value, then the value of the interpolation parametric function is corrected (S308), so as to eliminate the undesired noise signal. Herein the upper limit value and the lower limit value may be adjusted according to actual situation that effected by the noise signal, for example, the upper limit value and the lower limit value may be adjusted according to the frequency of the original voice signal and the sampling frequency of the sampling unit, and the correcting method of the value of the interpolation parametric function is, for example, if the value of the interpolation parametric function is greater than or equal to the upper limit value, then the value of the interpolation parametric function is corrected to be the upper limit value, and if the value of the interpolation parametric function is smaller than the lower limit value, then the value of the interpolation parametric function is corrected to be the lower limit value. After the value of the interpolation function is corrected, the frequency of the sampling voice signal is lowered to generate a frequency-lowered signal including a sequence of frequency-lowered signal frames (step S310), and then the interpolated value between the two adjacent sampling points in each of the frequency-lowered signal frames is calculated according to the value of the interpolation parametric function corresponding to each of the frequency-lowered signal frames (step S312). On the contrary, if the value of the interpolation parametric function is smaller than the upper limit value and greater than or equal to the lower limit value, then the step S310 may be directly performed, thereby lowering the frequency of the sampling voice signal.

In light of the foregoing, in the embodiment of the disclosure, the interpolated value between the sampling points is calculated by using trigonometric function, namely, the interpolated value between the two adjacent sampling points in the frequency-lowered signal frame is calculated according to the interpolation parametric function. Since the characteristics of trigonometric function and voice signal are comparatively similar, compared to the conventional method, a more precise interpolated value may be achieved, and thereby the situation that the frequency-lowered voice signal leads to signal distortion may be effectively avoided.

Although the disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

What is claimed is:

1. A voice signal processing apparatus, comprising:
a processing unit, receiving a sampling voice signal including a sequence of sampling signal frames, calculating a value of an interpolation parametric function corresponding to each of the sampling signal frames according to consecutive three sample values in each of the sampling signal frames, lowering a frequency of the sampling voice signal to generate a frequency-lowered signal including a sequence of frequency-lowered signal frames, calculating an interpolated value between two adjacent sampling points in each of the frequency-lowered signal frames according to a value of the interpolation parametric function corresponding to each of the frequency-lowered signal frames.

2. The voice signal processing apparatus as claimed in claim 1, further comprising:
a sampling unit, coupled to the processing unit, sampling an original voice signal to generate the sampling voice signal, the processing unit further determining whether the value of the interpolation parametric function is smaller than an upper limit value and greater than or equal to a lower limit value, if the value of the interpolation parametric function is not smaller than the upper limit value or not greater than or not equal to the lower limit value, correcting the value of the interpolation parametric function.

3. The voice signal processing apparatus as claimed in claim 2, wherein if the value of the interpolation parametric function is greater than or equal to the upper limit value, the value of the interpolation parametric function is corrected to be the upper limit value, if the value of the interpolation parametric function is smaller than the lower limit value, the value of the interpolation parametric function is corrected to be the lower limit value.

4. The voice signal processing apparatus as claimed in claim 3, wherein the upper limit value and the lower limit value are correlated to a frequency of the original voice signal and a sampling frequency of the sampling unit.

5. The voice signal processing apparatus as claimed in claim 1, wherein the processing unit further calculates the value of the interpolation parametric function corresponding to each of the sampling signal frames according to trigonometric relationship of the consecutive three sample values in each of the sampling signal frames.

6. The voice signal processing apparatus as claimed in claim 5, wherein the interpolation parametric function is a trigonometric function.

7. A voice signal processing method, comprising:
sampling an original voice signal to generate a sampling voice signal including a sequence of sampling signal frames;
calculating a value of an interpolation parametric function corresponding to each of the sampling signal frames according to consecutive three sample values in each of the sampling signal frames;
lowering a frequency of the sampling voice signal to generate a frequency-lowered signal including a sequence of frequency-lowered signal frames; and
calculating an interpolated value between two adjacent sampling points in each of the frequency-lowered signal frames according to a value of the interpolation parametric function corresponding to each of the frequency-lowered signal frames.

8. The voice signal processing method as claimed in claim 7, further comprising:
determining whether the value of the interpolation parametric function is smaller than an upper limit value and greater than or equal to a lower limit value, if the value of the interpolation parametric function is not smaller than the upper limit value or not greater than or not equal to the lower limit value, correcting the value of the interpolation parametric function.

9. The voice signal processing method as claimed in claim 8, wherein if the value of the interpolation parametric function is greater than or equal to the upper limit value, the value of the interpolation parametric function is corrected to be the upper limit value, if the value of the interpolation parametric function is smaller than the lower limit value, the value of the interpolation parametric function is corrected to be the lower limit value.

10. The voice signal processing method as claimed in claim 9, wherein the upper limit value and the lower limit value are correlated to a frequency of the original voice signal and a sampling frequency of the sampling unit.

11. The voice signal processing method as claimed in claim 7, further comprising:
calculating the value of the interpolation parametric function corresponding to each of the sampling signal frames according to trigonometric relationship of the consecutive three sample values in each of the sampling signal frames.

12. The voice signal processing method as claimed in claim 11, wherein the interpolation parametric function is a trigonometric function.
